(19) United States
(12) Patent Application Publication
(10) Pub. No.: US 2008/0011693 A1
(43) Pub. Date: Jan. 17, 2008

(54) Self-cleaning waste-water device and method

(76) Inventors: Ming Li, Plainsboro, NJ (US); ShaoXiang Lu, Plainsboro, NJ (US)

Correspondence Address: Ming Li, 12 Camas Court, Plainsboro, NJ, 08536, US

(21) Appl. No.: 11/486,340

(22) Filed: Jul. 12, 2006

(51) Int. Cl. B01D 17/00

(52) U.S. Cl. 210/802; 210/521; 210/540; 210/DIG. 5

(57) ABSTRACT

A self-cleaning waste-water treatment device and method having a housing; a waste-water inlet; a coalescing plate interceptor removably mounted within the housing comprising a plurality of corrugated separator plates each having apertures therein, for receiving the waste-water and for separating, via specific gravity, hydrocarbon-based contaminants from the waste-water; at least one ultrasonic generator disposed within the housing; contaminant removal means for removing separated hydrocarbon-based contaminants from the housing; a purified water outlet; and at least one baffle located adjacent to the purified water outlet.

### BACKGROUND OF THE INVENTION

The present invention relates to a self-cleaning waste-water treatment device and method for removal of hydrocarbon-based contaminants from storm and industrial waste-water. These contaminants include, but are not specifically limited to, gas, oil, diesel fuels, solvents, paint thinners and the like.

Each year, large quantities of sediment and other contaminants enter surface waters (such as streams, rivers, lakes etc.) due to rainwater runoff. Oftentimes, much of the water that falls during rainstorms goes directly to surface bodies of water by dedicated storm sewers. Oil, grease, antifreeze and other related hydrocarbon-based materials are contained in these flows due to storm water runoff from streets, parking lots and other sources of industrial traffic. Moreover, contaminated waste-water is also discharged into surface waters from construction and industrial activities.

Typically, waste-water is stored in enclosed holding tanks and drainage sumps until the waste-water is treated to remove the contaminants present therein.

Numerous methods have been developed for the removal of contaminants from waste-water. For example, agents such as chemicals, polymers, oxidizers and pH adjusters have been added to waste-water in order to chemically react with, and facilitate removal of, the contaminants. Chemical processes, however, often have the disadvantage of being time consuming and requiring complex reaction installations resulting in high capital cost. Moreover, qualified, licensed personnel trained in waste-water management are also required, further raising the cost of treatment. Many of these chemicals are considered hazardous materials and can pose their own hazards in storage, worker safety and possible release into the environment by accidental spills. In addition, chemical methods commonly cause the formation of gaseous wastes that also require proper disposal.

Chemical treatment is also insufficient in that it fails to remove fine suspended solids, which is also necessary for meeting governmental regulations for surface water. For example, certain regulations call for no more than 50-100 parts per million of suspended grease and oil contaminants be present in treated waste-water released back into the environment or into storm drains. The common practice for removing these suspended solids is the addition of chemical agents that are capable of bonding to the fine particles, such as aluminum sulfate, calcium hydrate compositions and sodium aluminate which are commonly used as chemical flocculating agents. Chemical flocculating agents, however, do not effectively remove solubilized waste components. They also can pose problems of storage and handling because some of these agents qualify as hazardous materials.

Another method for removal of contaminants from waste-water involves recharge basins. These basins allow storm water to pool and then slowly release back into the ground water supply through aquifers. A disadvantage of this process, however, is the possibility of contaminating the aquifer with pollutants from the storm water.

Water evaporation processes that yield a concentrated composition of waste contaminants have also been employed as a purification method. Water evaporation, however, has the disadvantage of being energy intensive, thus rendering this method of purification economically impractical. In addition, evaporation technologies are not energy efficient or resource efficient where water is expensive or in short supply.

Particle filtration is one more method that has been used to remove contaminants from waste-water. Reverse osmosis, which is ultra-fine filtration at high pressure using ceramic, filters out particles greater than about 2 microns in size. The problem with reverse osmosis is that the flow rate is too low to effectively treat large quantities of waste-water. Sand filters have also been used, but these filters also have a low flow rate, combined with the problem that they only filter out particles greater than about 50 microns.

A coalescing plate interceptor is one of the most effective physical methods for oil-water separation and removal. It is based on the rise-rate of oil droplets in the water and the surface-loading rate of the separator. However, the coalescing plate interceptor may experience clogging problems due to inappropriate design (spacing and inclination), accumulation of fine solid, heavy oil and grease present in wastewater. Sand entering the plate system can collect at the entrance to the plate assembly and reduce flow through the lower plate sections. Solids accumulation and clogging reduce the flow through the plates, thereby increasing operation and maintenance costs.

Thus, an object of the present invention is to provide a process and device for removing hydrocarbon-based contaminants from waste-water wherein the contaminants range in size from about 1 to about 300 microns in a simple, economical and environmentally-friendly manner.

### SUMMARY OF THE INVENTION

The present invention is directed to a self-cleaning waste-water treatment device for the removal of hydrocarbon-based contaminants from waste-water. The present invention solves the aforementioned problems by mechanically removing contaminants without the use of chemicals.

The self-cleaning waste-water treatment device of the present invention includes:
(a) a housing;
(b) a waste-water inlet;
(c) a coalescing plate interceptor disposed within the housing comprising a plurality of corrugated separator plates each having apertures therein, for receiving the waste-water and for separating, via specific gravity, hydrocarbon-based contaminants from the waste-water;
(d) at least one ultrasonic generator disposed within the housing;
(e) contaminant removal means for removing hydrocarbon-based contaminants from the housing;
(f) a water outlet; and
(g) at least one baffle located adjacent to the water outlet.

The present invention is also directed to a self-cleaning process for removing hydrocarbon-based contaminants from waste-water involving the steps of:
(a) providing a housing;
(b) providing a waste-water inlet;
(c) introducing waste-water into the housing via the waste-water inlet;
(d) providing a coalescing plate interceptor disposed within the housing, the interceptor comprising a plurality of corrugated separator plates each having apertures therein;
(e) contacting the waste-water with the corrugated separator plates in order to separate, via specific gravity, hydrocarbon-based contaminants from the waste-water;
(f) providing at least one ultrasonic generator disposed within the housing;
(g) generating ultrasonic energy within the housing in order to both inhibit clogging of the apertures present in the corrugated separator plates by contaminants passing therethrough as well as dislodge any contaminants present on any inner surface of the housing;
(h) providing contaminant removal means for removing the hydrocarbon-based contaminants from the housing;
(i) removing contaminants from the housing via the contaminant outlet;
(j) providing a water outlet;
(k) providing at least one baffle adjacent to the water outlet; and
(l) discharging purified water from the housing.

### BRIEF DESCRIPTION OF THE DRAWINGS

FIG. 1 is a cross-sectional side view of the waste-water treatment device of the present invention.

FIG. 2 is a perspective view of a corrugated separator plate of the present invention.

FIG. 3 is a perspective view of a plurality of corrugated separator plates stacked on top of one another at a predetermined angle.

### DETAILED DESCRIPTION OF THE PREFERRED EMBODIMENTS

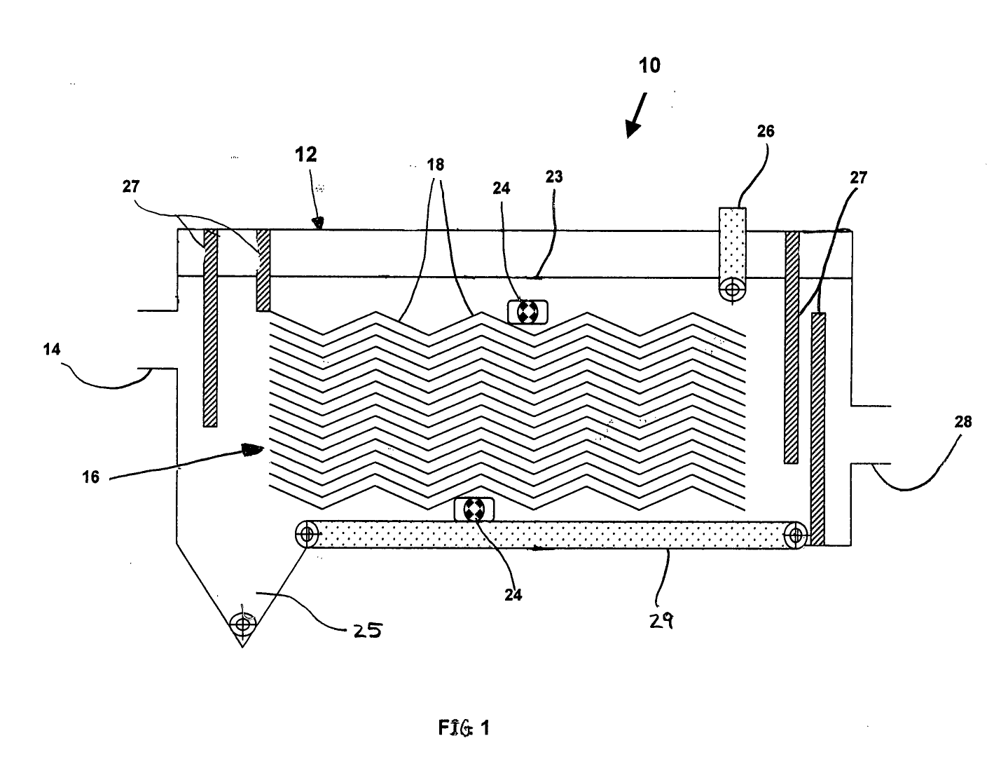

Referring now in greater detail to the various figures in the drawing, wherein like reference characters refer to like parts throughout, there in shown in FIG. 1 a self-cleaning waste-water treatment device 10 in accordance with the present invention. The device 10 comprises a housing 12 having a waste-water inlet 14 through which waste-water to be treated, enters into the housing. A coalescing plate assembly 16 used to treat the waste-water is disposed within the housing 12. The coalescing plate assembly 16 is comprised of a plurality of corrugated separator plates 18 stacked on top of one another.

The corrugated separator plates 18 may be made of any suitable, non-corrosive material. Preferably, the plates 18 are made of an oleophillic (i.e. oil attracting) material. Examples thereof include, but are not limited to, fiberglass, plastic, metal coated with an oleophillic material, and the like. Oil droplets cling to the plates 18 due to molecular attraction whereas conventional plates only trap the droplets by blocking their path to the surface.

The corrugated design of the plates 18 enables the coalescing plate assembly 16 to possess a large surface area for separating hydrocarbon-based contaminants from waste-water while occupying a minimal amount of space within the housing 12. Moreover, the presence of sloped surfaces on the plates 18 provides an anti-clogging effect allowing the plates 18 to clear themselves of sludge build-up on their own.

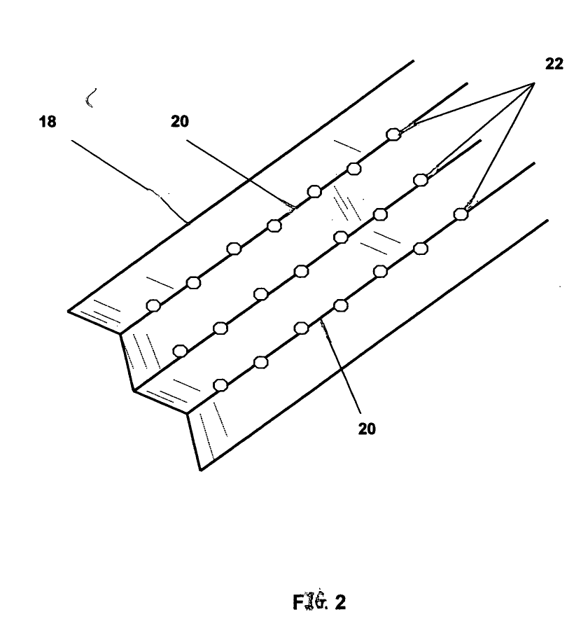

As is best seen in FIG. 2, the corrugated separator plates 18 form a plurality of ridges 20 having small apertures 22 present therein. As the hydrocarbon-based contaminants coalesce, they form a thin film of oil on the underside of the plates 18. The thin film of oil then flows in an upward direction to the top of the ridges 20 and passes through the apertures 22 onto the underside of the next plate 18 located above it. Eventually, the hydrocarbon-based contaminants move to the surface 23 of the waste-water within the housing 12.

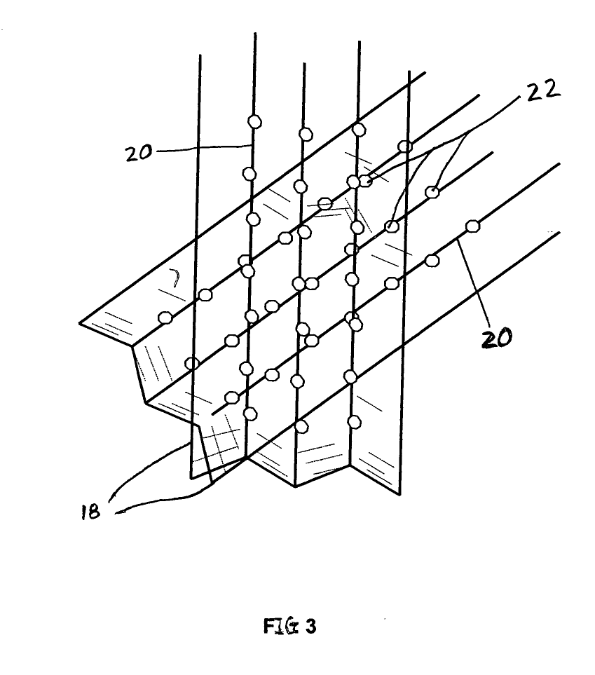

The plates 18 may be stacked atop one another such that they are arranged in the same direction, in parallel planes. However, according to a preferred embodiment of the present invention, best seen in FIG. 3, the plates 18 may be stacked in at least one alternating direction relative to each another such that they form a predetermined angle. The predetermined angle may vary from about 10° to about 80°, preferably from about 45° to about 60°. This type of plate configuration enables the plates 18 to be self-supporting, thereby eliminating the need for some sort of spacer/support means, while at the same time further increasing the available surface area of the coalescing plate assembly 16. The increased surface area provides for enhanced separation of the hydrocarbon-based contaminants from the waste-water.

In order to effectuate self-cleaning of the waste-water treatment device 10, at least one ultrasonic generator 24 is disposed within the housing 12. The ultrasonic generator 24 generates ultrasonic energy within the housing 12 in order to both inhibit clogging of the hydrocarbon-based contaminants as they travel through the apertures 22 of the plates 18, as well as to clean any surfaces present within the interior of the housing 12 by dislodging contaminants which may have accumulated thereon, thus allowing them to move to the surface of the waste-water within the housing for removal.

In a preferred embodiment of the present invention, best seen in FIG. 1, at least two ultrasonic generators 24 are disposed within the housing 12, one located near the bottom of the housing 12, and the other located near the top of the housing 12, in order to further enhance the self-cleaning properties of the device 10. Optionally, at least one sludge collection zone 25 may also be provided in order to collect large waste particles entering the waste-water treatment device 10 via the waste-water inlet 14. These large waste particles float down and collect in the sludge collection zone 25 so as not to interfere with the waste-water treatment process. If desired, sludge removing means 29 may also be provided in order to remove the accumulated large waste particles from the sludge collection zone 25.

The separated hydrocarbon-based contaminants present on the surface 23 of the waste-water are then removed from the housing 12 via contaminant removal means. One type of suitable contaminant removal means is a skimmer 26 which collects and/or directs the contaminants out from the housing 12. The skimmer 26 typically has an opening located at the surface 23 of the waste-water for collecting and directing the hydrocarbon-based contaminants out from the housing and into a contaminant storage tank (not shown) for subsequent disposal. It should be noted, however, that any means capable of collecting and/or directing the hydrocarbon-based contaminants from the surface 23 of the waste-water and into a contaminant storage tank may be employed without departing from the spirit of the invention.

A water outlet 28 is provided which enables purified water to exit the housing 12. At least one baffle 27 located adjacent to the water outlet 28 is provided in order to control and direct the flow of purified water out of the housing 12 via the water outlet 28. In a preferred embodiment, best seen in FIG. 1, at least two baffles 27, one mounted to the top of the housing 12 while the other is mounted to the bottom of the housing 12, are provided. It should be noted that one or more baffles may also be provided adjacent to the waste-water inlet 14 in order to control and direct the flow of waste-water into the housing 12 via the waste-water inlet 14.

In operation, waste-water containing hydrocarbon-based contaminants is pumped into the housing 12 through the waste-water inlet 14. The waste-water then comes in contact with the coalescing plate assembly 16 disposed within the housing. As the waste-water flows over and in between the corrugated separator plates 18, hydrocarbon-based contaminants in the form of droplets rise, i.e. separate from the waste-water by specific gravity due to the fact that they are lighter than water. As the hydrocarbon-based contaminants coalesce, they form a thin film of oil on the underside of the plates 18. The thin film of oil then moves in an upward direction to the top of the ridges 20 and passes through the apertures 22 onto the underside of the next plate 18 located above it. Eventually, the hydrocarbon-based contaminants move to the surface 23 of the waste-water within the housing 12. Once the contaminants reach the surface 23 of the water, they may be removed from the surface in any conventional way. For example, at least one skimmer 26 may be provided which has an opening at the surface level of the waste-water in order to skim the contaminants off the surface 23 of the waste-water and into a contaminant holding tank (not shown) for later disposal.

During the waste-water treatment process, either continually or periodically, the ultrasonic generator 24 is activated in order to both inhibit clogging of the contaminants in the apertures 22 of the plates 18 and clean any surfaces within the housing 12 of agglomerated contaminants. The ultrasonic generator 24 is releasably mounted within the housing 12 in order to facilitate ease of installation/replacement. One example of a suitable ultrasonic generator for use in the present invention is a Tube Resonator RS-36-30-X, 35 kHz manufactured by Telsonic USA of Bridgeport, N.J. The generator 24 may be operated using any conventional type of controller (not shown).

The purified water then exits the housing 12 via the purified water outlet 28 for further processing, if desired.

It is to be understood that the present invention is not limited to the sole embodiment described above and illustrated herein, but encompasses any and all variations falling within the scope of the appended claims.

What is claimed is:

1. A self-cleaning waste-water treatment device comprising:
(a) a housing;
(b) a waste-water inlet;
(c) a coalescing plate interceptor removably mounted within the housing comprising a plurality of corrugated separator plates each having apertures therein, for receiving the waste-water and for separating, via specific gravity, hydrocarbon-based contaminants from the waste-water;
(d) at least one ultrasonic generator disposed within the housing;
(e) contaminant removal means for removing separated hydrocarbon-based contaminants from the housing;
(f) a water outlet;
(g) at least one baffle located adjacent to the water outlet;
(h) optionally, at least one sludge collection zone; and
(i) optionally, at least one sludge removing means.

2. The device of claim 1 wherein the corrugated separator plates are made of an oleophillic material.

3. The device of claim 1 wherein the corrugated separator plates are stacked atop one another in uniform arrangement.

4. The device of claim 1 wherein the corrugated separator plates are stacked atop one another in alternating arrangement in order to form a predetermined angle in relation to each other.

5. The device of claim 4 wherein the predetermined angle ranges from about 10° to about 80°.

6. The device of claim 1 wherein two ultrasonic generators are removably mounted within the housing.

7. The device of claim 6 wherein one ultrasonic generator is located at an upper portion of the housing and the other ultrasonic generator is located at a lower portion of the housing.

8. The device of claim 6 wherein one ultrasonic generator is located at one side of the housing and the other ultrasonic generator is located at an opposite side the housing.

9. The device of claim. 1 wherein the contaminant removal means comprises at least one skimmer.

10. The device of claim 1 wherein the device is capable of removing contaminants from the waste-water which range in size from about 1 to about 300 microns.

11. A self-cleaning process for removing hydrocarbon-based contaminants from waste-water involving the steps of:
(a) providing a housing;
(b) providing a waste-water inlet;
(c) introducing waste-water into the housing via the waste-water inlet;
(d) providing a coalescing plate interceptor removably mounted within the housing, the interceptor comprising a plurality of corrugated separator plates each having apertures therein;
(e) contacting the waste-water with the corrugated separator plates in order to separate, via specific gravity, hydrocarbon-based contaminants from the waste-water;
(f) providing at least one ultrasonic generator removably mounted within the housing;
(g) generating ultrasonic energy within the housing in order to both inhibit clogging of the apertures present in the corrugated separator plates by contaminants passing there through as well as dislodge any contaminants present on any inner surface of the housing;
(h) providing contaminant removal means for removing contaminants from the housing;
(i) removing contaminants from the housing;
(j) providing a water outlet;
(k) providing at least one baffle located adjacent to the water outlet; and
(l) discharging purified water from the housing.

12. The process of claim 11 wherein the corrugated separator plates are made of an oleophillic material.

13. The device of claim 11 wherein the corrugated separator plates are stacked atop one another in uniform arrangement.

14. The process of claim 11 wherein the corrugated separator plates are stacked atop one another in alternating arrangement in order to form a predetermined angle in relation to each other.

15. The process of claim 14 wherein the predetermined angle ranges from about 10° to about 80°.

16. The process of claim 11 wherein two ultrasonic generators are removably mounted within the housing.

17. The process of claim 16 wherein one ultrasonic generator is located at an upper portion of the housing and the other ultrasonic generator is located at a lower portion of the housing.

18. The process of claim 16 wherein one ultrasonic generator is located at one side of the housing and the other ultrasonic generator is located at an opposite side the housing.

19. The process of claim 11 wherein the contaminant removal means comprises at least one skimmer.

20. The process of claim 11 wherein the device is capable of removing contaminants from the waste-water which range in size from about 1 to about 300 microns.
